(19) United States
(12) Patent Application Publication
(10) Pub. No.: US 2007/0039025 A1
(43) Pub. Date: Feb. 15, 2007

(54) Method for application sharing

(75) Inventors: Christian Kraft, Frederiksberg C (DK); Peter Dam Nielsen, Kgs Lyngby (DK); Jyri P. Salomaa, Jorvas (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/199,382

(22) Filed: Aug. 9, 2005

(51) Int. Cl. H04N 7/16; H04N 7/20; H04N 7/14

(52) U.S. Cl. 725/62; 348/14.01; 725/73

(57) ABSTRACT

Provided are apparatuses and methods in a mobile transmission system for sharing data between mobile terminals. Application data such as a video image including, for example, a television program, a computer application, or a gaming application may be transmitted from one mobile terminal to another mobile terminal in real-time so that multiple users may view the data or video images simultaneously and in real-time.

### FIELD OF THE INVENTION

The invention relates generally to sharing TV or application data among users. More specifically, the invention provides for sharing data through a video phone call in broadcast transmission systems.

### BACKGROUND OF THE INVENTION

Digital broadband broadcast networks enable end users to receive digital content including video, audio, data, and so forth. Using a mobile terminal, a user may receive digital content over a wireless digital broadcast network. Digital content can be transmitted wirelessly using a fixed data rate, such as provided by the MPEG-TS (Moving Pictures Experts Group Transport Stream) standard.

A mobile communication device may display an image of a remote user during a video phone call. Typically, an image of the remote user is obtained through a camera positioned at the remote site. The image is transmitted from the camera at the remote site to the local mobile communication device and displayed on a display on the local mobile communication device. The local user can communicate with the remote user while viewing a video image of the remote user on the display on the local mobile communication device. In addition, a camera located at the local site generates video images of the local user which is transmitted locally to the local mobile communication device and remotely to the remote user. The video images of the local user can be displayed at the local mobile communication device, typically in a smaller window on the display on the local mobile communication device.

However, there is currently no efficient method or system for sharing real-time TV or application data with a remote user over a mobile communication network. Hence, users are presently unable to communicate efficiently with remote users. Methods and systems are needed to enable more efficient transmissions, particularly in wireless digital broadcast networks.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of the invention provide for a method and system for sharing data between devices. For example, a first mobile terminal may receive or generate data which may include video images such as a television program. The first mobile terminal may transmit the data to a second mobile terminal that is located remotely from the first mobile terminal. The second mobile terminal can display the received data in real time and approximately simultaneously with the first mobile device.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system in which one or more illustrative embodiments of the invention may be implemented.

FIG. 2 is a block diagram illustrating a portion of a mobile terminal and receiver in which one or more illustrative embodiments of the invention may be implemented.

FIG. 3 illustrates an example of a suitable mobile terminal or device in which one or more illustrative embodiments of the invention may be implemented.

FIG. 4 is a flowchart illustrating an example of sharing of data between devices in which one or more illustrative embodiments of the invention may be implemented.

FIG. 5 illustrates an example of transmission of television content from a mobile terminal or device to another mobile terminal device in which one or more illustrative embodiments of the invention may be implemented.

FIG. 6 illustrates the example of FIG. 5 including an input device for inputting sound according to one or more illustrative embodiments of the invention.

FIG. 7 illustrates an example of a video telephone call according to one or more illustrative embodiments of the invention.

FIG. 8 illustrates an example of transmission of television content between mobile terminals or devices during a video telephone call according to one or more illustrative embodiments of the invention.

FIG. 9 illustrates an example of a menu for selection of content of a display of a mobile terminal or device according to one or more illustrative embodiments of the invention.

FIG. 10 illustrates an example of a video call option menu according to one or more illustrative embodiments of the invention.

FIG. 11 illustrates an example of sharing of application data between mobile terminals or devices according to one or more illustrative embodiments of the invention.

FIG. 12 illustrates an example of sharing a gaming experience between mobile terminals or devices according to one or more illustrative embodiments of the invention.

FIG. 13 is a flowchart illustrating an example of selection of an application for transmission from a first device to a second device according to one or more illustrative embodiments of the invention.

FIG. 14 illustrates an example of an options menu for selecting data to be shared between mobile terminals or devices according to one or more illustrative embodiments of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

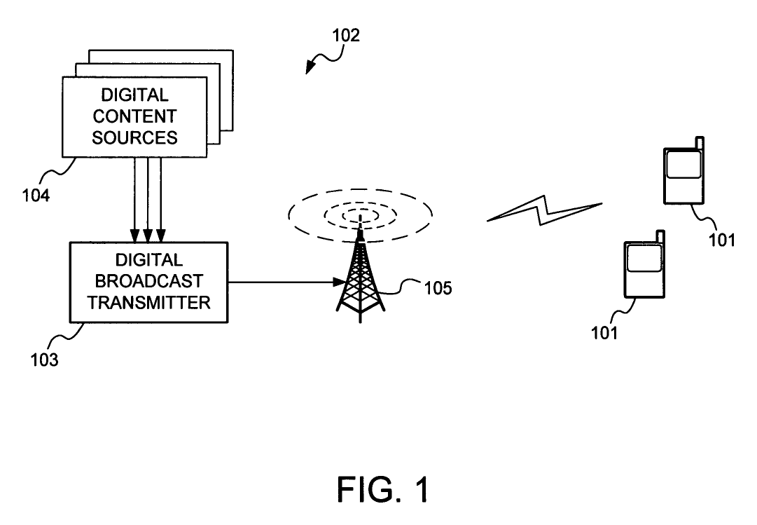

FIG. 1 illustrates a suitable digital broadband broadcast system 102 in which one or more illustrative embodiments of the invention may be implemented. Systems such as the one illustrated here may utilize a digital broadband broadcast technology, for example Digital Video Broadcast-Handheld (DVB-H). Examples of other digital broadcast standards which digital broadband broadcast system 102 may utilize include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used.

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission implements) for wireless transmission. Ultimately, mobile terminals 101 may selectively receive and consume digital content originating with digital content sources 104.

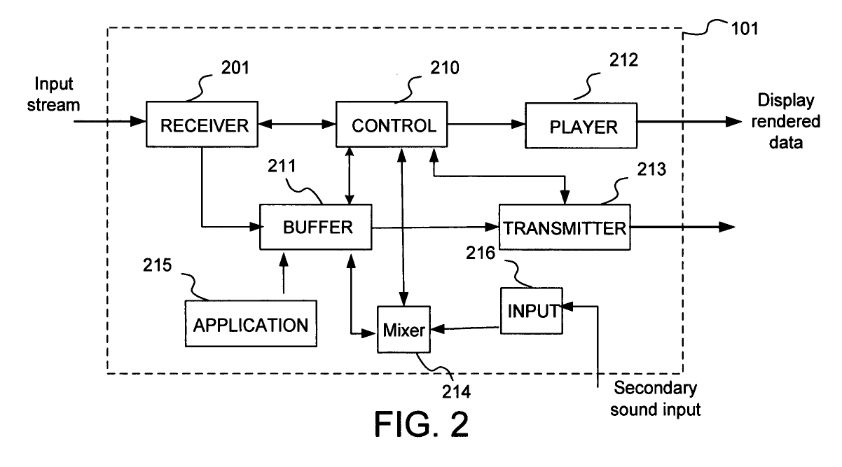

FIG. 2 illustrates an example of one suitable mobile terminal 101 in which one or more illustrative embodiments of the invention may be implemented. Although one particular design is provided, functional blocks provided here may be combined, rearranged, separated, or even skipped.

An incoming signal can be received by mobile terminal 101 at a receiver 201. In this example, the received data is processed in the receiver 201 and sent to a buffer 211 that can buffer the received data for optimal data presentation. The mobile terminal 101 may further include an interface block or control 210, which may be embodied in a computer-readable medium, for example, for controlling data storage in the buffer 211 and presentation and display of the data. Further, an executable software application such as a player 212 or other functional block which may be embodied on a computer-readable medium may be included in the mobile terminal 101 for presentation of the data. The mobile terminal 101 may further include a transmitter 213 for transmitting data to a remote device. Data transmission from the buffer 211 to the transmitter 213 and transmission of data from the transmitter 213 may be controlled by the control 210. The control 210 may provide for transmission of the data from the transmitter 213 upon input of a command as described herein.

The mobile terminal 101 may also include a mixer 214 for mixing sound and/or video. As illustrated in FIG. 2, secondary input audio data may be input into the mobile terminal 101 through input 216. For example, input 216 may be a microphone configured to receiving secondary input audio data.

An example of mixing of the secondary input audio data with the received data or data from an application 215 is illustrated in FIG. 2. In one example, input data is received at receiver 201 that includes a video component and an audio component. The audio component can be separated from the video component so that the audio component can be mixed with the secondary input audio data. In this example, the audio component of the input data is received at the mixer 214 after the audio component of the input data is separated from the video component of the input data. The mixer also receives the secondary input audio data and mixes the audio component of the input data with the secondary input audio data. The resulting mixed audio data is then combined with the video component of the input data and transmitted from the buffer 211 to the transmitter 213 for transmission to the remote device. The secondary input sound can be any type of input including voice input from a user. If a user inputs voice data as secondary input sound, the voice data is mixed with the video and/or audio components of the input stream and transmitted via the transmitter 213 as described.

In another example of mixing secondary input sound, an application 215 running at the mobile terminal 101 provides audio and video data. The audio data associated with the application 215 can be separated from the video data and mixed with secondary input sound at the mixer 214. The mixed sound data (i.e., the audio data associated with the application 215 mixed with the secondary input sound) can be stored in a buffer 211 and sent to transmitter 213 for transmission to a remote device.

In another example of mixing secondary input sound, audio data associated with an application 215 or input data received at the receiver 201 is stored in a buffer 211 and transmitted to a remote device by transmitter 213. Secondary input sound is received via input 216 (e.g., a microphone) and also stored in the buffer 211 and transmitted to the remote device by transmitter 213. In this example, the secondary input sound is mixed with the audio and/or video components of the input data received at the receiver 201 or the audio and video data associated with application 215 after transmission by transmitter 213. Some non-limiting examples of application data that may include an audio component include a gaming application or a computer application configured to run on the mobile terminal 101.

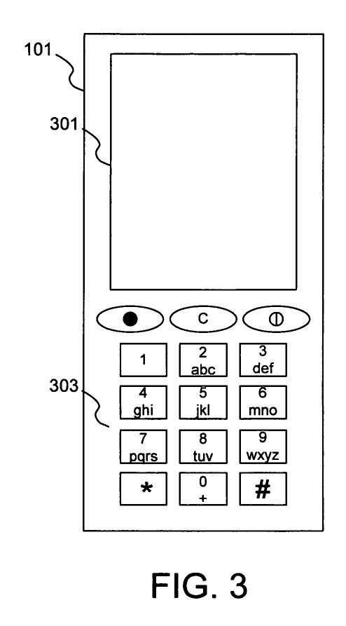

In an example of the present invention, a mobile terminal 101 may display video images of the digital content received from the digital content sources 104 on a display. FIG. 3 illustrates an example of a mobile terminal 101 including a display 301 for displaying digital content and a keypad 303. In this example, television content may be received from a television broadcasting station and displayed on the display 301. However, the invention is not so limited as any data may be shared between devices. Such data may include but is not limited to video and/or audio data from a gaming application or any application data such as data from a word processing application, spreadsheet application, etc.

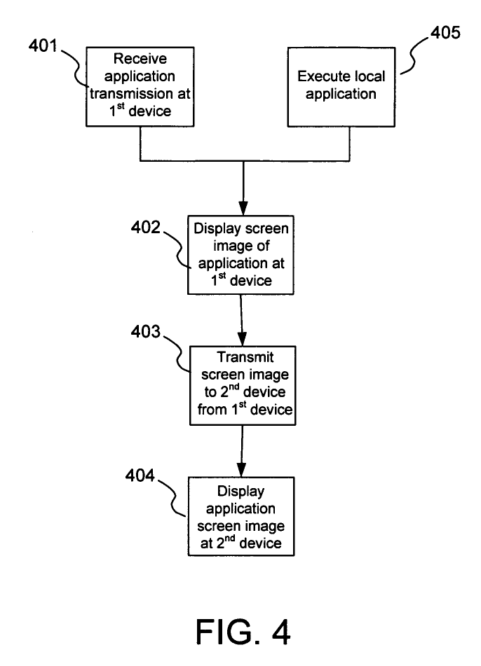

FIG. 4 is a flowchart illustrating an example of sharing of data between devices. In Step 401, a transmission is received at a first device. The transmission includes any application data. For example, the transmission may include a television program broadcast from a television broadcast station or data. Alternatively, video images from an application, such as a gaming application or word processing application, can be executed locally (Step 405). The received video images or application data is displayed on a display screen on the first device in Step 402 so that a user at the first device may observe a screen image on a display of the first device. The screen image and application data may be transmitted to a second device (Step 403). The second device may be remote from the first device and may be a mobile terminal. The application data received at the second device is displayed as a screen image on a display on the second device (Step 404). This information may include video images and/or sound associated with the application data and may be presented in real-time on the display on the second device. Also, the screen image on the second device is the same as the screen image on the first device and may be presented on the second device simultaneously with the screen image on the first device.

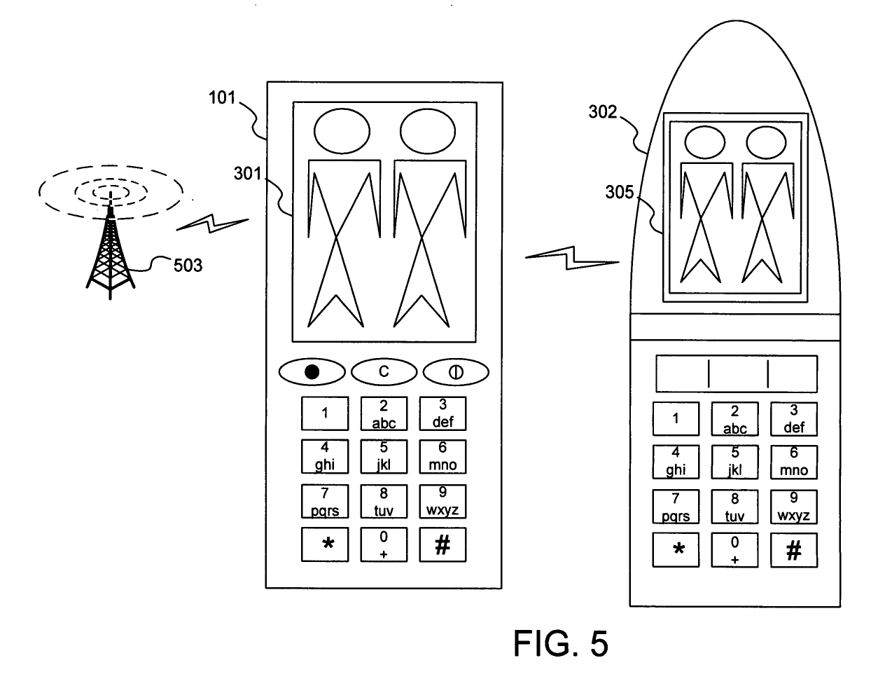

FIG. 5 illustrates another example in which the television broadcasting station 503 transmits television content to a first mobile terminal 101. However, a second mobile terminal 302 that is remote from the first mobile terminal 101 and the television broadcasting station 503 does not receive the television content from the television broadcasting station 503. For example, the second (remote) mobile terminal 302 may lack access to the television content from the television broadcasting station 503 or may be located out of range of the television broadcasting station 503. If a user at the first mobile terminal 101 watches television and discovers a television program that he wishes to share and/or discuss with remote users, the user at the first mobile terminal 101 can transmit the desired television content to any desired remote user through the first mobile terminal 101. The user at the second mobile terminal 302 may view the television program received from the first mobile terminal 101 at approximately the same time and in real-time. Optionally, the user may also transmit additional sound data mixed with the television content.

In this example, the first mobile terminal 101 receives the television content (depicted schematically in FIG. 5) from the television broadcasting station 503, displays the television content on a display 301 and transmits the television content to the second (remote) mobile terminal 302. The television content is received at the second mobile terminal 302 from the first mobile terminal 101 and displayed on a display 305 on the second mobile terminal 302 in real-time. Hence, the first mobile terminal 101, which receives television content from the television broadcasting station 503, and the second mobile terminal 302, which receives the television content from the first mobile terminal 101, display the television content on their respective displays (301, 305, respectively) approximately simultaneously. However, the invention is not limited in this respect.

In another example, the first mobile terminal 101 may downscale the media prior to transmitting the television content to the second mobile terminal 302. For example, the first mobile terminal 101 may re-encode the media to improve bandwidth. Also, downscaling the video may include sampling video frames from the video data at a certain frequency and sending the sampled video data from the first mobile terminal 101 to the second mobile terminal 302. Thus, only portions of the video data are transmitted to improve bandwidth, the transmitted portions of the video data being the sampled video frames of the video data. In this example, the non-sampled frames of the video data are not transmitted, thus preserving bandwidth. For example, the first mobile terminal 101 may transmit every third video frame. The frequency of sampling may be selected based on a variety of factors including desired video quality, desired degree of smoothness of playback of video, etc. Also in this example, the audio data associated with the television content is transmitted to the second mobile terminal 302 without a large reduction in sampling rate—i.e., substantially all of the corresponding audio data is sent from the first mobile terminal 101 to the second mobile terminal 302. If substantially all of the audio data is sent to the second mobile terminal 302, then the audio received and played at the second mobile terminal 302 will be of the original quality (in terms of e.g. audio band width) or close to the original quality even if the video image might not be.

The user at the first mobile terminal 101 may also record the television content prior to transmitting the television content to the second mobile terminal, if desired. However, the user at the first mobile terminal 101 need not record the television content prior to sending the television content to the user at the second (remote) mobile terminal 302. Rather, both users can share the experience of the television content in real-time (i.e., “live”) as the television content is provided from the television broadcasting station 503.

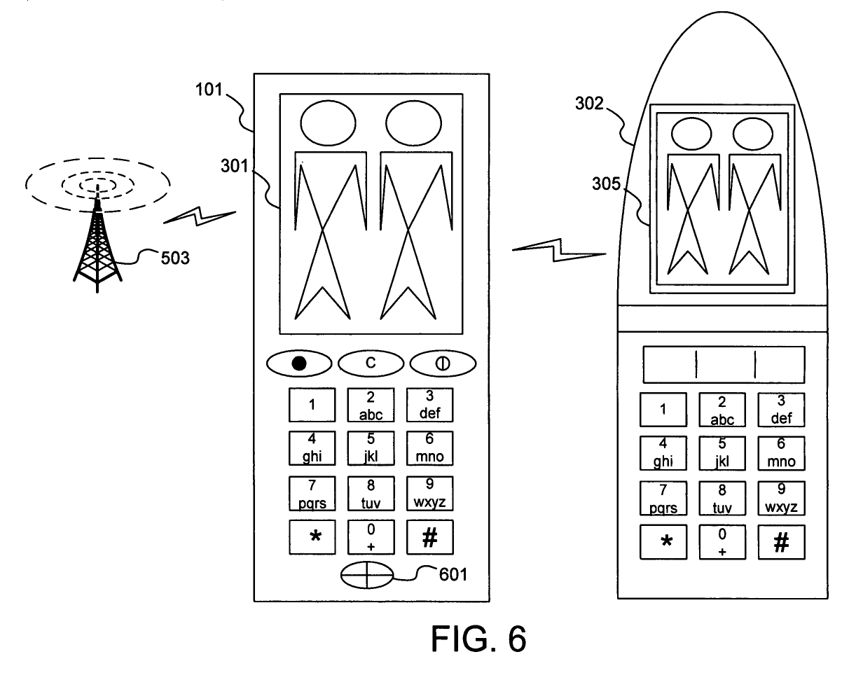

FIG. 6 illustrates the example of FIG. 5 in which the first mobile terminal 101 includes a voice-input device 601 so that a user can input his/her voice or other desired sounds in combination with the television content. In this example, the television content includes video and audio components and is received from the television broadcasting station 503. The video is displayed on a display 301 of the first mobile terminal 101 and the audio is played through an output such as a speaker on the first mobile terminal 101. The first mobile terminal 101 transmits the received television content to the second (remote) mobile terminal 302 as described above. Additionally, the user at the first mobile terminal 101 may wish to include comments or any additional sounds with the television content being transmitted to the second (remote) mobile terminal 302. For example, the first mobile terminal 101 may include a voice-input device 601 such as a microphone so that the user of the first mobile terminal 101 may input additional sounds (e.g., spoken words, sound clips, etc.) into the first mobile terminal 101. One non-limiting example is the user can input his/her own voice into the transmission as input sound. The input sound can be then mixed with the sound of the television content and transmitted to the user at the second (remote) mobile terminal 302. Mixing of the sound of the television content with additional input sound may be accomplished as described above. If desired, the volume of the sound of the television content may be decreased or muted to enhance clarity of the sound input at the first mobile terminal 101.

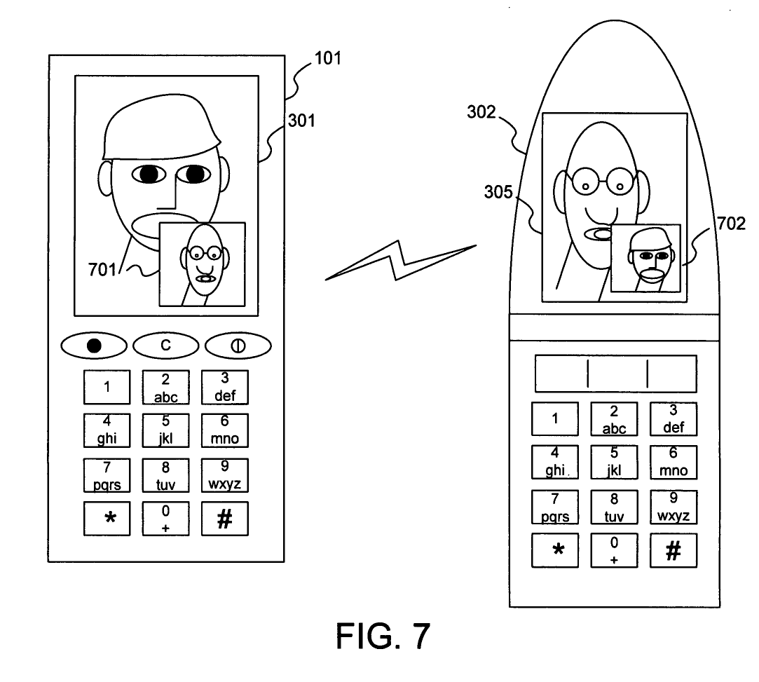

FIG. 7 illustrates an example in which the user at the first (local) mobile terminal 101 and the user at the second (remote) mobile terminal 302 are engaged in a video telephone call. During the video telephone call of this example as shown in FIG. 6, the display 301 on the first mobile terminal 101 displays an image of the remote user (i.e., the user at the second mobile terminal 302 in this example) and a smaller image 701 (i.e., a “thumbnail”) of the local user (the user at the first mobile terminal 101 in this example). Likewise, the display 305 of the second mobile terminal 302 displays an image of the local user and a smaller image 702 (thumbnail) of the remote user. If additional users participate in the video call, additional thumbnails may be provided on the respective displays (not shown) corresponding to each of the additional participants. In this way, all users (or selected users) can view video images of all participants (or selected participants) in the video telephone call.

The local user can receive television content from a remote content source. For example, the local user receives a television program broadcast from a television broadcast station 503 and displays the television program on a display 301 on the first mobile terminal 101. The local user can control whether the received television program is displayed on the display 301 of the first mobile device 101, as a thumbnail 701 on the display 301 or if a local camera image of the local user should be displayed on the display 301 or as a thumbnail 701, or if both the received television program and the local camera image of the local user should be displayed, either one being displayed on the display 301 or as a thumbnail 701.

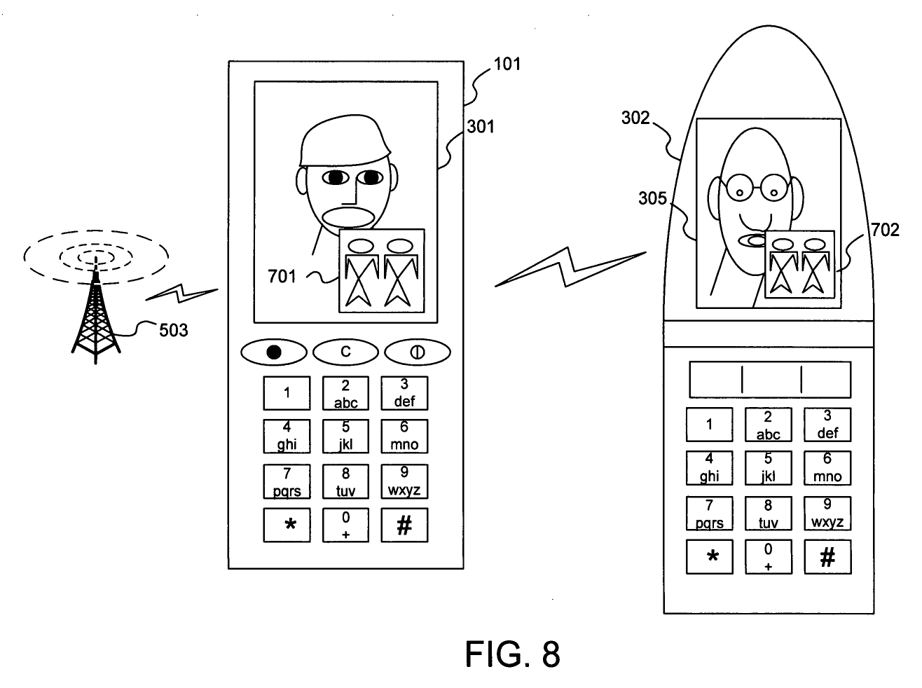

FIG. 8 illustrates the television program displayed on the display 301 of the first mobile device 101 and on the display 305 of the second mobile device 302. In this example, the television program broadcast is received at the first (local) mobile device 101 from the television broadcast station 503 and displayed on the display 301 of the first mobile device 101. The second mobile device 302 is remote from the first mobile device 101 and the television broadcast station 503. The second mobile device 302 does not receive the television program broadcast from the television broadcast station 503. Instead, the first mobile device 101 transmits the video image of the television program broadcast to the second (remote) mobile device 302. The second mobile device 302 receives the television program broadcast from the first mobile device 101 and displays the video and audio of the received television program broadcast. The video may be displayed on the display 305 of the second mobile device 302 or as a thumbnail 702 on the display 305 of the second mobile device 302. In the example illustrated in FIG. 8, the display 305 of the second mobile device 302 displays a video image of the caller (i.e., the user of the first mobile device 301) and a thumbnail 702. The thumbnail 702 displays the television program broadcast received from the first mobile device 101. Alternatively, the television program broadcast may be displayed on the display 305 of the second mobile device 302 instead of the video image of the first user depending on the needs of the users. The television program broadcast may thus be displayed in real-time on the display 301 of the first mobile device 101 (or as a thumbnail 701) and on the display 305 of the second mobile device 302 (or as a thumbnail 702) approximately simultaneously. In this way, the television program broadcast may be shared between users in a communication system.

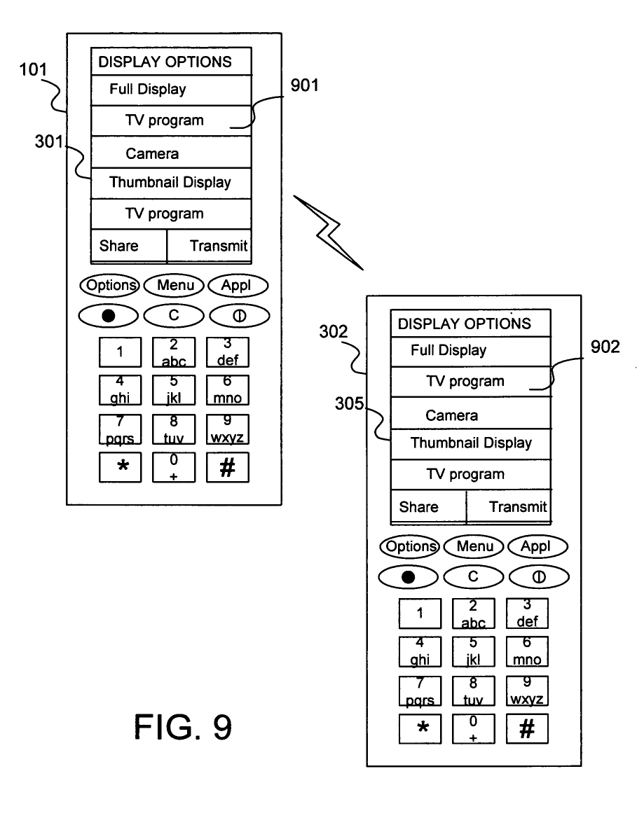

The content of the displays (301, 305) of the first and second mobile devices (101, 302), respectively, can be determined by a user. FIG. 9 illustrates an example of a menu which permits a user to select a setting for the content of the display or the content of a thumbnail display. In this example, the user may define whether the display 301 provides the television program broadcast or the local camera image or some other desired images in the thumbnail during the video call with the second mobile device 302. An options menu 901 may be displayed and may list the options that are displayable on the display 301 of the mobile device 101. A user may select the desired option. For example, if the user wishes the television program broadcast to be displayed in the thumbnail 701 on the display 301 of the first mobile device 101 (see FIG. 7 or FIG. 8), then the user can select the corresponding selection on the options menu 901 (i.e., the TV program selection in this example). The television program broadcast may then be displayed as a thumbnail 701 on the display 301 during the video call. Alternatively, the user may select the local camera image of the user to be displayed as the thumbnail 701 on the display 301. In another example, the options menu 901 may display a list of options that may be transmitted to the mobile device 302. The user may select a desired option such that the selected transmission is transmitted from the mobile device 101 to the mobile device 302. For example, if the user of mobile device 101 wishes to share the television program broadcast with the user of the mobile device 302, then the user can select the TV program option on the options menu 901 to start forwarding the television program broadcast to the mobile device 302. In yet another example, the mobile terminal 101 may downscale the media prior to transmitting the television content. For example, the mobile terminal 101 may re-encode the media to improve bandwidth.

The user at the second mobile device 302 may also select the display 305 and/or the thumbnail 702 on the display. For example, the user at the second mobile device 302 (which can be remote from the first mobile device 101) may wish to view the television program broadcast received from the user at the first mobile device 101. If so, the user at the second mobile device 302 may select the corresponding selection on the options menu 902. In this example, the user at the second mobile device 302 may select the TV program option on the options menu 902 on the display 305 of the second mobile device 302. This can result in the display of the television program broadcast received from the first mobile device 101. The television program broadcast may be displayed on the display 305 of the second mobile device 302. Alternatively, the television program broadcast may be displayed as a thumbnail 702 on the display 305. Hence, the user at the first mobile device 101 and the user at the second mobile device 302 may watch the same television program in real-time and approximately simultaneously. The television program that is either displayed on the displays of the mobile devices in the video call (i.e., 101 and 302 in this example) may be an ongoing television program that was playing when the video call was created. If there is no television program running when the video call was created, the last television channel that was used may be used as the thumbnail image. Alternatively, a traditional video call image may be shown as the thumbnail (e.g., an image of the user at the other device).

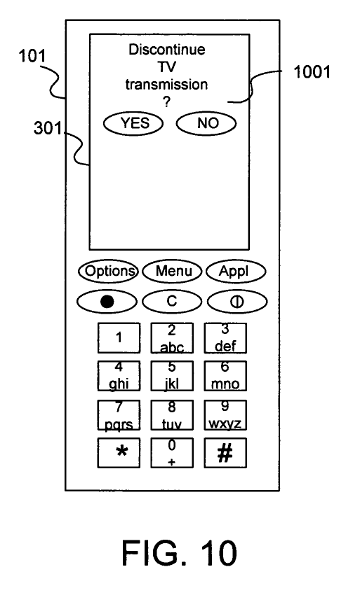

During transmission of a received television program broadcast from a first mobile device to a second (remote) mobile device, the user at the first mobile device may discontinue transmission of the television program broadcast to the second mobile device while maintaining the display of the received television program broadcast at the first (local) mobile device. FIG. 10 illustrates an example of the present invention in which a television program broadcast is received at a first mobile device 101, displayed on a display 301 on the first mobile device 101 and transmitted from the first mobile device 101 to a second (remote) mobile device. The second mobile device receives the television program broadcast from the first mobile device 101 and displays the television program in a thumbnail on the display on the second mobile device as described above. However, the user at the first mobile device 101 in this example wishes to discontinue the transmission of the television program broadcast to the second mobile device. The user at the first (local) mobile device 101 may select an option from the video call's options menu to switch off the transmission of the television program broadcast. FIG. 10 illustrates an example of a video call option menu 1001 containing an option to discontinue the television program broadcast transmission. Selection of the option can result in discontinuation of transmission of the television program broadcast transmission to the second (remote) mobile device.

The present invention is not limited to transmission of television content. Any data transmission received at a mobile device or data generated or present at a mobile device may be shared with another mobile device in real-time. In “See What I See” (SWIS), real time person-to-person communication may be accomplished in which one user may share data with another user. This may further be accomplished during a voice and/or video call.

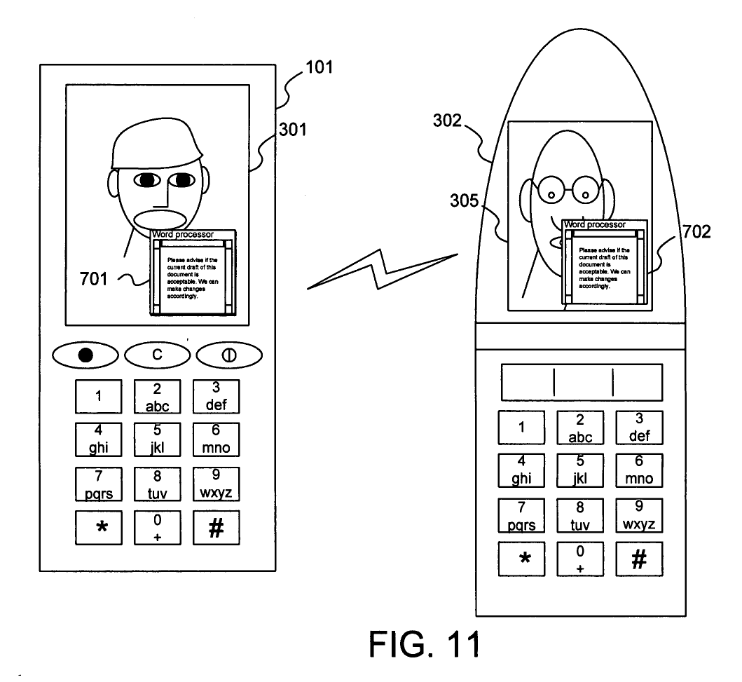

In another non-limiting example of SWIS, a user at a first mobile device may generate data in an application and share the data with another user at a remote second mobile device. FIG. 11 illustrates an example in which a word processing application is running at a first mobile device 101. The document in the word processing application may be displayed on the display 301 of the first mobile device 101. The document may also be displayed as a thumbnail 701 on the display 301 of the first mobile device 101. The user at the first mobile device 101 may wish to share the data with another (remote) user. The user at the first mobile device 101 may transmit an image of the document to the other (remote) user at a second mobile device 302. The remote user at the second mobile device 302 may receive the transmission from the first user and display the image of the document in the word processing application on the display 305 of the second mobile device 302. The document image may also be displayed as a thumbnail 702 on the display 305 (as shown in the example of FIG. 11).

In this example, the application is shared between remote users in real-time. If the user at the first mobile device 101 changes the document in the application (e.g., changes the text in a word processing application, changes data in a spreadsheet application, changes in a data management program, changes in a money management program, etc.), the changes are reflected in the displayed application at the second mobile device 302. FIG. 11 illustrates a document in a word processing application displayed at the first mobile device 101. Changes are made to the document at the first mobile device 101 which are displayed at the second mobile device 302 in real-time. Hence, multiple users may collaborate on the data and work together to discuss changes in the data even if each of the multiple users is located at a remote location.

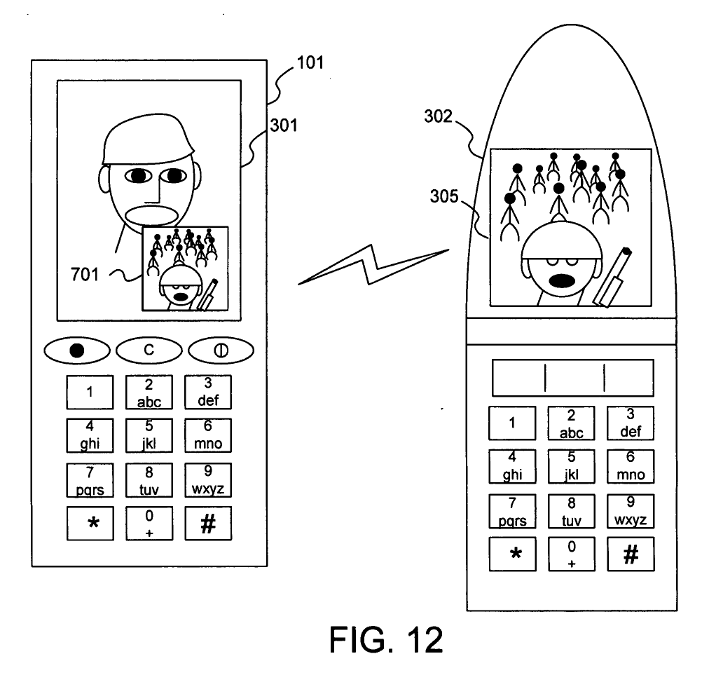

In another example of SWIS, a gaming experience is shared between participants in a video game. Typically a player in an electronic/video game sees the contents of an application window from his own perspective on a display. The video image seen on the display corresponds to a character's viewpoint. However, the player typically does not have access to the video image as seen by other, remote players in the game (i.e., from the perspective of other players). In this example of the present invention illustrated in FIG. 12, a player of a game may transmit the screen video image of the game in progress (from the player's perspective) to a second (remote) game participant. The video image and/or sound is displayed at the first mobile device 101. In the example illustrated in FIG. 12, the image of the game application is displayed on the display 301 of the first mobile device 101 as a thumbnail 701. The video image and/or sound is transmitted to and received at the second mobile device 302 and displayed on the display 305 or in a thumbnail (not shown) on the display 305 of the second mobile device 302. In addition, the user may also combine voice or other input sounds with the sound of the video game. For example, the first mobile device 101 may include an audio input component such as a microphone. The user can input sound into the input component which can be mixed with a separated audio component of the game application. After transmission of the image of the game application, the video image and/or sound component of the game application can be presented at the second mobile device 302. In addition, the sound input by the user at the first mobile device 101 can be provided at the second mobile terminal 302. In this way, players may communicate during game play as well as share video images of the game.

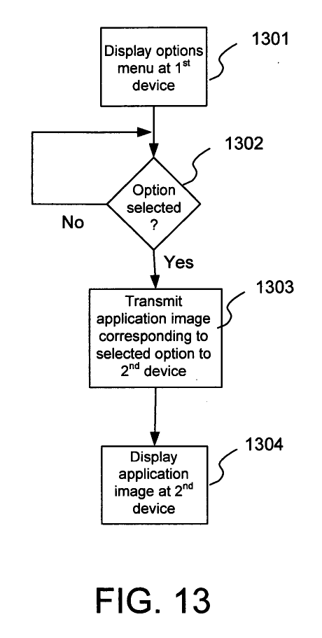

FIG. 13 illustrates an example of selection of an application for transmission from a first device to a second device. In this example, an options menu may be displayed on a first device (Step 1301). The menu may contain a list of applications that are running on the first device, for example. In Step 1302, a selection of an option from the list of options is received. For example, a selection of an application to transmit to a second device may be selected from a list of applications running on the first device. If an option is selected (the “YES” branch of Step 1302), the application corresponding to the menu option is transmitted to the second device (Step 1303). The application may include video images and/or sound that can be displayed on the second device. The second device receives an image of the application from the first device and displays the application data (Step 1304). For example, video images on the first device may be sent to the second device and displayed on the second device such that the video images are seen in real-time and approximately simultaneously on both the first device and the second device.

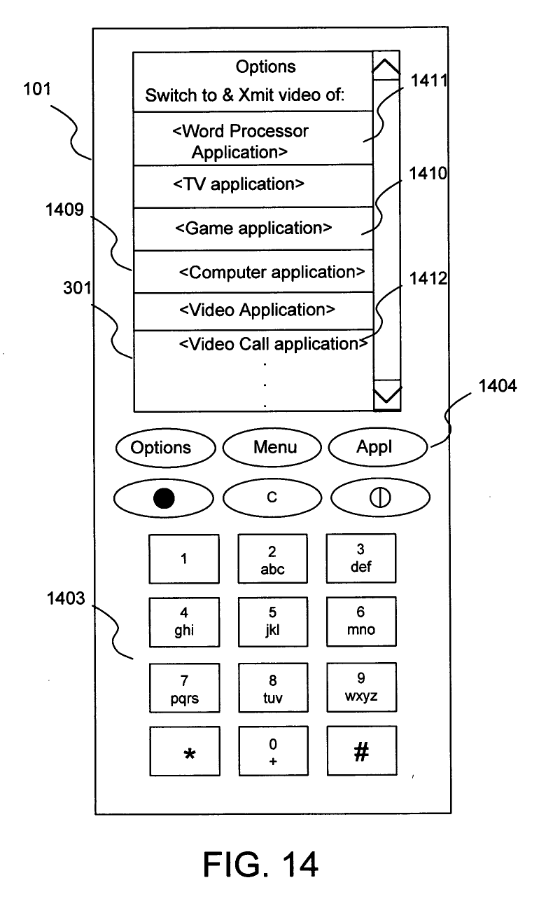

This example is illustrated in FIG. 14 in which multiple applications may be running on a mobile device. For example, a game application, word processing application, spreadsheet application, and television broadcast application may be running on the mobile device simultaneously. Any of the video images may be transmitted to a second (remote) user and may be displayed on a display at the second mobile device as described. An options menu may be displayed on a display 301 of the mobile device that may list all of the applications that are running on the mobile device, some of which may be running in the background. In the example illustrated in FIG. 14, a mobile device 101 is running a word processing application in which a word processing document may be displayed on the mobile device 101, a television application in which a television program may be displayed on the mobile device, a gaming application in which a video game application may be displayed, any computer application such as a spreadsheet application or file management application, any video application such as a display of video that may be playing on the mobile device, or video call application itself (i.e., the application for control, management, and operation of the video call between multiple users). The present invention is not limited to these applications as any application that may be run on the mobile device may be transmitted to another mobile device.

An option from the options menu 1409 may be selected such that the selected option (i.e., an image of the corresponding application that is running on the mobile device) may be transmitted to another mobile device. As an example, a gaming application option 1410 that is running on a mobile device may be selected. The gaming application includes a display of the game in progress. This display may be transmitted to another mobile device (e.g., other players in the game) so that the mobile device(s) receiving the image of the gaming application can display the image of the game in real-time. The resulting display may correspond to the images seen by the mobile device that sends the application in real-time. Hence, in this example, the sending mobile device and the receiving mobile device(s) can display the game application in progress and in real-time as seen by the sending mobile device.

Similarly, an image of a document in a word processing application can be sent from a sending mobile device to another (receiving) mobile device or devices by selection of the corresponding word processing option 1411 from the option menu 1409. After selection of the word processing application option 1411 on the menu 1409, the image of the word processing application can be displayed on the receiving mobile device(s) in real-time at approximately the same time. If the user at the first mobile device alters the document, the alteration may be seen as images on the display of all of the receiving devices in real-time. Alternatively, the alterations may be reflected only on selected devices. The option menu 1409 may be displayed as an overlay in the display such that the video images may still be seen underneath the overlay. In another example, the option menu 1409 may be displayed in a portion of the display so that a portion of the video images are still visible. In yet another example, the option menu 1409 may be displayed in the entire display such that other menus from the video phone menu would be obscured. In this case, the selection of running applications on the mobile device may be displayed in many ways. For example, an application key 1404 may be provided on the mobile device such that a long key-press on the application key 1404 causes the selection list of running applications to be displayed on the display. Selection of a corresponding video call application returns the video call to the foreground of the display.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. A method for sharing data in a mobile transmission system comprising the steps of:
receiving a video image at a first mobile terminal from a video source, the video source being remote from the first mobile terminal;
displaying the video image at the first mobile terminal; and
the first mobile terminal transmitting the video image to a second mobile terminal so that the transmitted video image can be displayed at the first mobile terminal and the second mobile terminal approximately simultaneously.

2. The method of claim 1 wherein the transmitting step includes the step of conducting a video conference call between the first mobile terminal and the second mobile terminal.

3. The method of claim 2 wherein the video image includes a second video stream.

4. The method of claim 1 wherein the video image is displayed at the first mobile terminal and the second mobile terminal in real-time.

5. The method of claim 1 wherein the video image comprises a television program.

6. The method of claim 1 wherein the video image includes a corresponding first sound component and wherein the method further comprises receiving a second sound input.

7. The method of claim 6 wherein the second sound input is mixed with the first sound component of the video image.

8. The method of claim 1 wherein the mobile transmission system comprises a Digital Video Broadcasting-Handheld (DVB-H) system.

9. The method of claim 1 wherein the data further includes audio data corresponding to the live video image, the step of transmitting comprising:
sampling the video image at a predetermined frequency; and
transmitting the sampled video image and substantially all of the audio data.

10. A mobile terminal configured to transmit a video image of an application to another mobile terminal comprising:
a receiver for receiving a video image from a video source, the video source being remote from the mobile terminal;
a display for displaying the video image; and
a transmitter for transmitting the video image to a second mobile terminal so that the video can be displayed on the display and the second mobile terminal approximately simultaneously.

11. The mobile terminal of claim 10 wherein the data is transmitted within a video conference call that is conducted between the first mobile terminal and the second mobile terminal.

12. The mobile terminal of claim 10 wherein the video image includes a second video stream.

13. The mobile terminal of claim 10 wherein the video image includes an audio component.

14. The mobile terminal of claim 13 further comprising a sound input for receiving audio data.

15. The mobile terminal of claim 14 further comprising a mixer for combining the audio component of the video image with audio data received from the sound input.

16. The mobile terminal of claim 15 wherein the transmitter further transmits audio data received from the sound input mixed with the video image.

17. The mobile terminal of claim 10 wherein the video image comprises a television broadcast.

18. The mobile terminal of claim 17 wherein the video source is a television broadcast station.

19. A method for sharing data in a mobile transmission system comprising the steps of:
executing an application program at a first mobile terminal;
generating in the first mobile terminal a video image from the application program executing in the first mobile terminal;
displaying the video image at the first mobile terminal; and
the first mobile terminal transmitting the video image to a second mobile terminal so that the transmitted video image can be displayed at the first mobile terminal and the second mobile terminal approximately simultaneously.

20. The method of claim 19 wherein the transmitting step includes the step of conducting a video conference call between the first mobile terminal and the second mobile terminal.

21. The method of claim 20 wherein the video image includes a second video stream.

22. The method of claim 19 wherein the video image is displayed at the first mobile terminal and the second mobile terminal in real-time.

23. The method of claim 19 wherein the video image is a video image of a gaming application.

24. The method of claim 23 wherein the video image of the gaming application corresponds to a perspective of a player of the gaming application.

25. The method of claim 19 wherein the application is a word processing application and the video image includes a video image of a word processing document.

26. The method of claim 19 wherein the application is a spreadsheet application and the video image includes a video image of a spreadsheet document.

27. The method of claim 19 wherein the video image includes a corresponding first sound component and wherein the method further comprises receiving a second sound input.

28. The method of claim 27 wherein the second sound input is mixed with the first sound component of the video image.

29. The method of claim 19 wherein the data further includes audio data corresponding to the live video image, the step of transmitting comprising:
sampling the video image of the data at a predetermined frequency; and
transmitting the sampled video image and substantially all of the audio data.

30. A mobile terminal configured to transmit a video image of an application to another mobile terminal comprising:
a control block for executing an application and for generating a video image of the application;
a display for displaying the video image of the application; and
a transmitter for transmitting the video image to a second mobile terminal so that the data can be displayed on the display and the second mobile terminal approximately simultaneously.

31. The mobile terminal of claim 30 wherein the video image is transmitted within a video conference call that is conducted between the first mobile terminal and the second mobile terminal.

32. The mobile terminal of claim 30 wherein the video image includes a second video stream.

33. The mobile terminal of claim 30 wherein the video image includes an audio component.

34. The mobile terminal of claim 33 further comprising a sound input for receiving audio data.

35. The mobile terminal of claim 34 further comprising a mixer for combining the audio component of the video image with audio data received from the sound input.

36. The mobile terminal of claim 35 wherein the transmitter further transmits audio data received from the sound input mixed with the input data.

37. The mobile terminal of claim 30 wherein the application is selected from the group consisting of a gaming application, a word processing application, and a spreadsheet application.

38. A method for sharing data in a mobile transmission system, the method comprising the steps of:
receiving input data at a first mobile terminal from a video source, the input data including a video component and an audio component and the video source being remote from the first mobile terminal;
displaying the video component of the input data on a display at the first mobile terminal in real-time;
outputting the audio component of the input data from the first mobile terminal in real-time;
receiving a secondary audio input at the first mobile terminal;
mixing the received secondary audio input with the audio component of the input data;
transmitting the input data from the first mobile terminal to a second mobile terminal so that the input data can be displayed at the first mobile terminal and the second mobile terminal approximately simultaneously, the transmitted input data including the received secondary audio input mixed with the audio component of the input data,
wherein the secondary audio input is output approximately simultaneously with the audio component of the input data at the second mobile terminal.

39. A computer-readable medium having computer-executable instructions for performing steps comprising:
receiving a video image at a first mobile terminal from a video source, the video source being remote from the first mobile terminal;
displaying the video image at the first mobile terminal; and
the first mobile terminal transmitting the video image to a second mobile terminal so that the transmitted video image can be displayed at the first mobile terminal and the second mobile terminal approximately simultaneously.

40. The computer-readable medium of claim 39 further comprising computer-executable instructions for conducting a video conference call between the first mobile terminal and the second mobile terminal.

41. The computer-readable medium of claim 39 wherein the video image comprises a television program.

42. A computer-readable medium having computer-executable instructions for performing steps comprising:
executing an application program at a first mobile terminal;
generating in the first mobile terminal a video image from the application program executing in the first mobile terminal;
displaying the video image at the first mobile terminal; and
the first mobile terminal transmitting the video image to a second mobile terminal so that the transmitted video image can be displayed at the first mobile terminal and the second mobile terminal approximately simultaneously.

43. The computer-readable medium of claim 42 wherein the displayed video image corresponds to a perspective of a user of the application at the first mobile terminal.

44. The computer-readable medium of claim 43 wherein the application is selected from the group consisting of a gaming application, a word processing application and a spreadsheet application.
